(19) United States
(12) Patent Application Publication
(10) Pub. No.: US 2012/0306201 A1
(43) Pub. Date: Dec. 6, 2012

(54) FLUID-COOLED LOAD RESISTOR FOR USE IN ENERGY PRODUCTION AND USE THEREFOR

(75) Inventor: Per Hassel Sorensen, Sandnes (NO)

(73) Assignee: Energreen AS

(21) Appl. No.: 13/579,750

(22) PCT Filed: Feb. 17, 2011
(86) PCT No.: PCT/NO11/00056

§ 371 Date: Aug. 17, 2012

(30) Foreign Application Priority Data
Feb. 18, 2010 (NO) 20100247

(51) Int. Cl. H02P 9/02; H01C 1/08

(52) U.S. Cl. 290/7; 338/53

(57) ABSTRACT

A load resistor device for a generator driven by a turbine in a fluid string wherein the load resistor is provided with at least one electrical element in heat conducting connection with the turbine driving fluid. Also described is a method for use of such a device.

The invention relates to a device for an electrical load resistor. More particularly the invention concerns an electric load resistor for a generator being driven by a turbine in a fluid string and where the electric load resistor gives off energy to said fluid string.

By a turbine is here meant any machine wherein a fluid may produce a rotational movement of one or more shafts. Such turbines may for example, but not limited to, be a Francis turbine, a Pelton turbine, a cross-flow turbine, an Archimedean screw, a Turgo turbine and a Kaplan turbine. By turbine is also meant all types of pumps used as turbines.

A generator for production of energy may be driven by a turbine. Various types of media drive the turbine directly or indirectly. It may for example be driven by water as in a hydroelectric power station or a wave power station, by steam as in a thermal power station or nuclear power station, by wind as in a windmill or by the exhaust gases from an internal combustion engine.

A turbine and a generator are designed to be operated within certain margins. A generator may be tied to an electric distribution grid. Those apparatuses and installations tied to the electric distribution grid use energy when in use and constitute a load for the generator. The turbine must via the generator overcome this load to be able to rotate the generator rotor. At power failure in the electrical distribution grid, hereafter called grid loss, the load is suddenly reduced. A water, steam or wind driven turbine will thereby be able to increase rotational speed, so-called overspeeding, and the rotational speed may exceed the range the turbine and the generator are designed for.

At grid loss there are more ways to stop or decelerate the turbine. In a hydroelectric power station the flow of water may be reduced or stopped altogether by means of valves. An internal combustion engine driving a generator may be stopped by cutting the fuel supply. A windmill may be decelerated by brakes on the turbine shaft. Common for several of these mechanical actions at grid loss are that there arises a time delay from the failure happens and to the generator is stopped completely.

It is known in the art to use a so-called load resistor, also known as a brake resistor, to stabilise a generator at a grid loss until the generator is stopped in other ways. In the following the term load resistor will mean an electrical load resistor. A load resistor will further denote an apparatus constituted by structural and electrical components. The electrical components also comprise at least one electrical element, which may be a resistor, an induction element or a condenser. This electrical element works as a load on a generator. A load resistor may therefore render a respectively resistive load, inductive load and capacitive load. The value of the load resistor's load is decided by the electrical characteristics of the electrical element and how many electrical elements that the load resistor is provided with. In the following the connection of a resistive element to a generator will be denoted directly connected, while the connection of an inductive element to the generator will be denoted indirectly connected. An inductive element is made up of a coil and a core. By an inductive element is meant both the coil and the core if nothing else is clearly expressed.

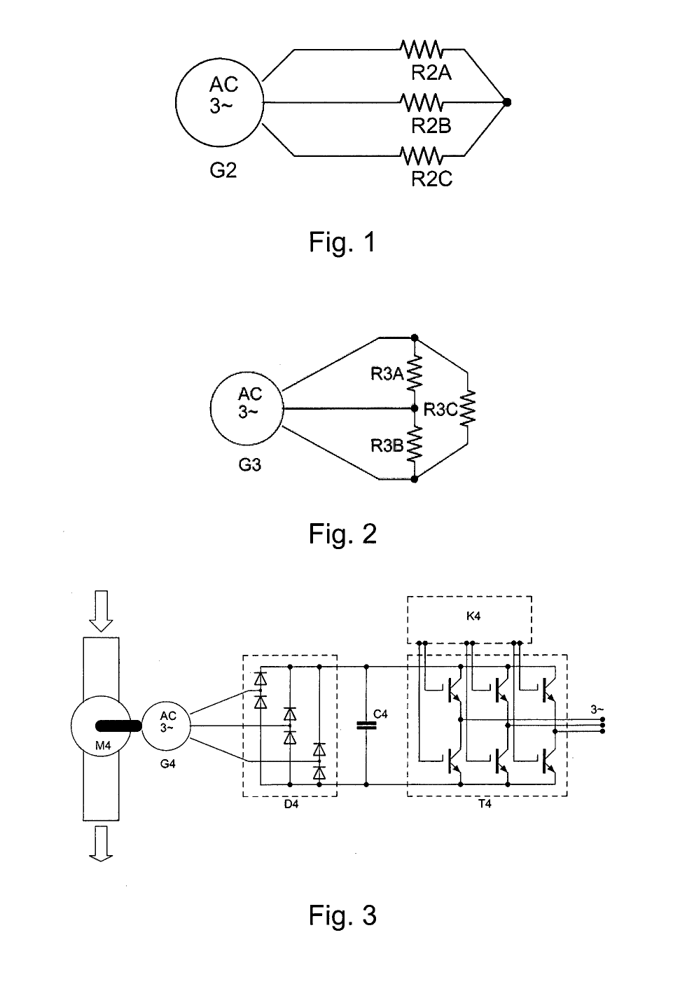

The heat energy created in the electrical element is used to heat a fluid in the form of a gas or a liquid. The gas may be air and the liquid may be water or oil. An electric element has the advantage that it may be connected up quickly at grid loss. Several types of directly connected electrical elements are known in the art. Principally they consist of a resistor heating a fluid such as air, freshwater, seawater or an oil, such as transformer oil, and which via a heat exchanger transfers the heat to air or water. It is further known to be is advantageous to have one electrical element for each phase when a load is connected to a multi-phase generator, as shown with star-connected electrical elements R2A, R2B and R2C in FIG. 2 and delta-connected electrical elements R3A, R3B and R3C in FIG. 3.

In the following the fluid being heated by an electric element and giving off heat to another medium across such as a heat exchanger, will be denoted as a cooling fluid.

The patent document US 2007/0164567 describes the use of a dump load resistor for use for windmills to reduce the load on the windmill structure at braking of the propeller on a grid loss.

It is often necessary to reduce the pressure in a fluid flow, and a simple and well known solution consists in letting the fluid flow pass a choke, for example in the form of a choke valve wherein the choking effect may be adjusted to obtain the desired pressure reduction. A large part of the energy loss as a consequence of the pressure reduction in choking, may however be captured and transformed to useful energy by replacing the choke valve with a turbine driving an electric generator connected to an electrical load. The pressure reduction obtained may be adjusted by adjusting the electrical load on the generator.

The patent document U.S. Pat. No. 4,496,845 describes the use of a turbine in a water supply system, wherein the turbine connected in parallel to a traditional pressure reduction valve provides for a pressure drop in the pipeline network. At a grid loss the speed of the turbine will increase before the valves close the water supply to the turbine to stop it. The water will then flow past the turbine through the pressure reduction valve connected as a bypass to the turbine.

The patent document WO 2008/004880 describes a turbine being driven by a fluid string in a pipe. The main purpose of the turbine is to replace traditional pressure reduction valves in such as a pipeline network for consumption water such as drinking water. By using such a pressure reduction turbine, the energy may be made useful by the turbine driving a generator. The generator may supply electrical energy to several types of consumers. In a simple set-up the generator may supply a load such as a heating element for heating, an electric light source or an electric fan motor to make local use of the energy. The generator may also be connected to an electric distribution grid, which is mainly supplied, from a larger power plant, and where the energy from the generator may constitute a useful addition. The generator may thus be in contact with the ordinary electrical distribution grid. The advantage in this solution is that it does not require rebuilding of the pipeline as it only replaces a reduction valve and does not take up appreciably more space than a reduction valve. It may therefore be retrofitted in existing pipeline networks such as a network for consumer water.

As opposed to many other turbines, a pressure reduction turbine, as described in WO 2008/004880, should not be stopped at grid loss, as it is not desirable that a grid loss shall reduce or stop the supply of, or the pressure in, such as consumer water in a network. It is further a problem that a generator supplying power to an area hit by a grid loss, will give so-called islanding. This constitutes a danger to maintenance personnel believing that an area is unpowered due to grid loss, while the grid is still powered by the running generator. In some cases a pressure reduction turbine described in WO 2008/004880 together with a generator function as a stand-by power unit at a grid loss. In such a case there may be a requirement that the generator shall be able to be regulated to give the desired power, but not more power. In other such cases there may be a requirement that the water production and the pressure control shall continue unimpeded. The energy produced shall cover the local energy needs, while any surplus energy must be diverted to another form of energy than electrical energy.

The load on the generator driven by a pressure reduction turbine is regulated according to the need for pressure reduction instead of the need for electrical energy. The generator is therefore connected to an alternative load in case the useful load is dropped or the desired pressure reduction cannot be met with available useful load.

Using one or more load resistors of known type may solve the mentioned problems in the operation of a pressure reduction turbine. The load resistor may for example be air-cooled. This involves however a drawback in the form of extra installations in connection with the generator. In known solutions the load resistor is dimensioned for short-term operation because the turbine will be braked down after a few seconds with a mechanical brake, or the water flow will be reduced or stopped. Owing to the fact that a pressure reduction turbine shall function also during grid loss to supply water at desired amount and pressure; it means that the energy production must continue even at a grid loss. This means that isolated operation is a necessary mode for pressure reduction turbines.

Typical values for the amount of energy to be received in one or more load resistors connected to a turbine of this type constitute 20-500 kW. An air-cooled load resistor will thus require some space and must have extensive aeration with accompanying fans and ducting. A liquid-cooled load resistor is will require less room. One problem in known, liquid-cooled load resistors is that in the load resistor plate heat exchanger or between the load resistor pipe bundles cavities are formed that are difficult to keep clean, and bio-film may arise in these cavities. Such load resistors are often provided with motors for operation of fans and pumps, increasing the maintenance requirements and reducing the operational reliability as these may stop when they are needed during a grid loss. Air-cooled or liquid-cooled load resistors complicate retrofitting of a pressure reduction turbine. The investment is more costly and may entail that installation of such a pressure reduction turbine will not pay.

There is therefore a need to provide a simple load resistor for a generator driven by a turbine, which reduces the pressure in a fluid string. By fluid string is meant a fluid which wholly or partly fills the inside cross-sectional area of a pipe. Preferably the fluid is incompressible and may for example, but not limited to be water or oil. The fluid may also be a gas.

The object of the invention is to remedy or reduce at least one of the disadvantages of the prior art, or at least provide a useful alternative to the prior art. The object of the invention is thus to procure an electric load resistor device that may constitute an alternative for a generator, and where the load resistor may be used alone or in combination with a useful load.

The object is achieved by the features disclosed in the below description and in the subsequent claims.

The load resistor shall be simple to fit to a pressure reduction turbine, it shall have a simple design easy to maintain, and shall not require much space. The load resistor must be able to serve the full capacity of the pressure reduction turbine for some considerable time.

In a load resistor device according to the invention, electrical energy from the generator is transformed to heat in a per se known way. It has surprisingly turned out to be favourable to transfer heat from the load resistor to the driving fluid of a turbine, either upstream or downstream of the turbine or in the turbine housing. By utilising the driving fluid as cooling fluid in a load resistor, a cooling effect adapted to the electrical energy production is obtained. The larger the through flow, the larger the energy production, and the larger the cooling effect in the load resistor at grid loss. This reduces the safety margins used in dimensioning the load resistor. In the following the term driving fluid denote the fluid driving a turbine. The driving fluid may be the cooling fluid. The driving fluid also comprises the fluid coming out of the turbine.

To avoid that an electric element is in direct contact with the driving fluid, the heat transfer may be done by heat exchanging between a separate cooling fluid receiving heat from the load resistor electric element giving off heat to the driving fluid. Heat transfer may also be achieved by placing electric elements in thermal contact with the outside of a pipe wall made of a material having good thermal conductivity and where the driving fluid flows in contact with the inside of the pipe wall.

Electrical elements or heat exchanger elements may be placed in a liquid filled annulus between a pipe for the driving fluid and an external casing.

It may be advantageous to separate the electrical element galvanically from the generator. This can be achieved simply by means of a transformer, and the necessary AC may be obtained in that the generator is an AC generator, or by using a converter for DC to AC if the generator is a DC dynamo. An advantage in using a converter is that the AC frequency may be chosen. It is known to use such converters together with an AC generator wherein the electric current is rectified and then changed to AC. An advantage with such an arrangement is that the AC frequency is independent of the generator rotational speed. Another advantage is that the AC frequency may be increased to achieve a smaller physical size for a connected transformer.

In a first aspect the invention relates to a load resistor for a generator driven by a turbine in a fluid string, wherein the load resistor is provided with at least one electrical element heat conductingly connected to the turbine driving fluid.

The load resistor electric element may be in heat conducting connection with a heat conducting pipe wall surrounding the driving fluid. The heat conducting pipe wall may be constituted by a metal.

The load resistor electric element may be placed in an annulus where one wall of the annulus is constituted by a portion of a heat conducting pipe wall surrounding the driving fluid. The annulus may be provided with a cooling fluid, and the electrical element may be in heat conducting connection with the cooling fluid. The cooling fluid may be fluid, which is both heat inert and fire inert. An example of a fluid, which is both heat and fire inert, is a transformer oil of a per se known type.

The longitudinal direction of the annulus in the operating position may be substantially vertical. This has the advantage that the cooling fluid in the annulus may form a convection flow where the hottest fluid flows up along the pipe wall surrounding the driving fluid and the cooled fluid flows back along the outer wall of the annulus. It may be particularly advantageous if the hottest cooling fluid flows in a direction different from the flow direction of the driving fluid and it is particularly advantageous if the cooling fluid flows in a direction opposite to the direction of the driving fluid.

In an alternative embodiment the vertical annulus may be provided with an expansion chamber of a per se known type to attend to a thermal expansion of the cooling fluid. A horizontally directed annulus may correspondingly be provided with an expansion chamber.

In a further alternative embodiment the load resistor may be provided with an inductively connected electrical element. A portion of the pipe wall may constitute the inductively connected electrical element. In a further alternative embodiment a portion of a turbine housing may constitute the inductively connected electrical element.

The load resistor may be provided with a plurality of electrical elements where the electrical elements are connected to different phases and where the electrical elements may be connected in parallel. This has the advantage that at large current intensities several electrical elements may be connected in parallel in each phase.

A control unit for the generator may be arranged to distribute the generator produced electrical energy between a distribution grid and the load resistor. This has the advantage that at normal operation the produced electrical energy from the generator is provided to the ordinary distribution grid. At grid loss the turbine may keep up its function undisturbed, while the energy produced may be directed to one or more of the load resistor electrical elements so that the energy produced is used to heat the driving fluid. The control unit may also be arranged such that the turbine with its generator functions as a backup power unit at grid loss. The control unit may be arranged to measure the voltage and the frequency of the local grid to be served by the backup power unit and supply electrical power in accordance with this, while any surplus energy is directed to the load resistor.

A pressure reduction turbine will often give a continuously varying revolution speed to a generator. This entails that the AC from the generator must be converted to an AC with fixed frequency, typically 50 or 60 Hz for it to be forwarded to normal power consumers. A frequency converter may be used for this purpose. By connecting a load resistor having a resisting element to the generator AC output one is no longer dependent on a frequency converter to be able to reduce the pressure in the fluid string. It will then be possible to load the generator and thereby reduce the pressure in the fluid string even if the frequency converter stops functioning.

The driving fluid may be consumer water, such as drinking water, or oil.

In a second aspect the invention relates to an embodiment for operation of a turbine being driven by a driving fluid in a network where the turbine is provided with a generator arranged to supply electrical energy to a distribution grid via a control unit, such that the control unit at grid loss is arranged to direct the electrical energy produced to a load resistor provided with at least one electrical element in heat conducting connection with the turbine driving fluid.

The control unit may be arranged for in a known way, as in a backup system, to measure the electric voltage and frequency in a local distribution grid and provide the local distribution grid with electric energy according to the measured voltage and to direct surplus energy to the load.

In the following are described examples of preferred embodiments illustrated in the accompanying drawings, wherein:

FIG. 1 shows a known schematic block diagram for a three-phase AC generator with star-connected electrical elements;

FIG. 2 shows a known schematic block diagram for a three-phase AC generator with delta-connected electrical elements;

FIG. 3 shows a known schematic block diagram for a three-phase AC generator with a frequency converter for supply of constant AC at varying turbine rotational speed;

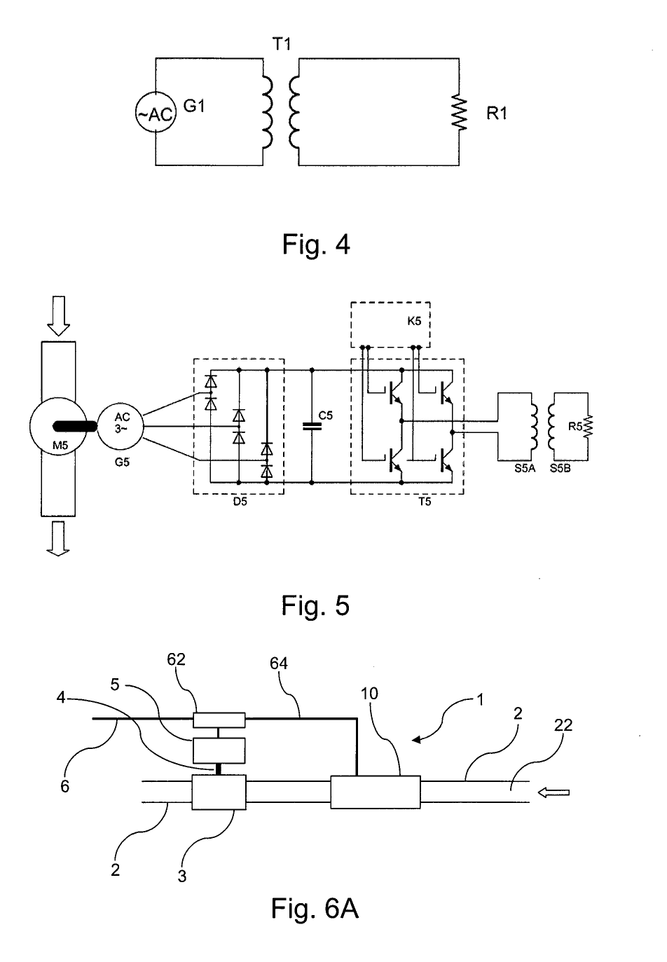

FIG. 4 shows a known schematic block diagram for an AC generator and an electrical element constituted by an inductive element;

FIG. 5 shows a known schematic block diagram for a three-phase AC generator with a frequency converter and an electrical element constituted by an inductive element;

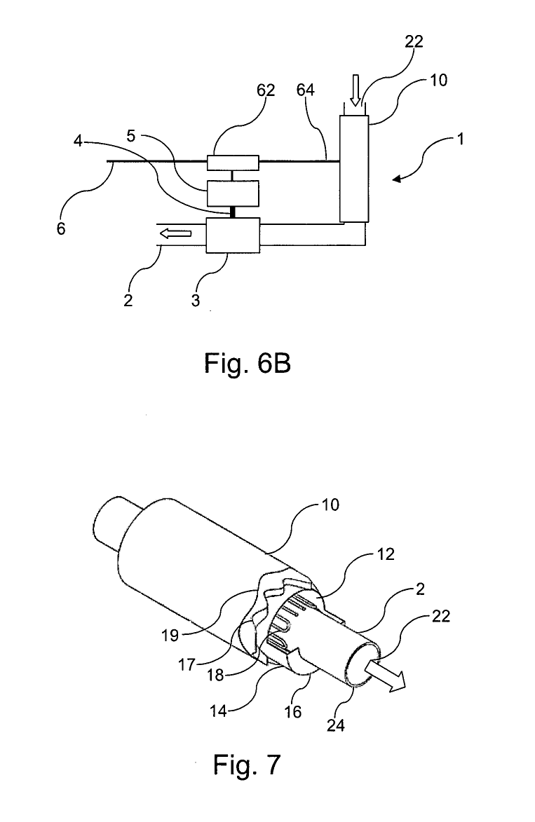

FIG. 6A-B shows schematically the invention for a load resistor in heat conducting connection with a driving fluid;

FIG. 7 shows a cut through perspective view of an electric element in a load resistor in heat conducting connection with a driving fluid;

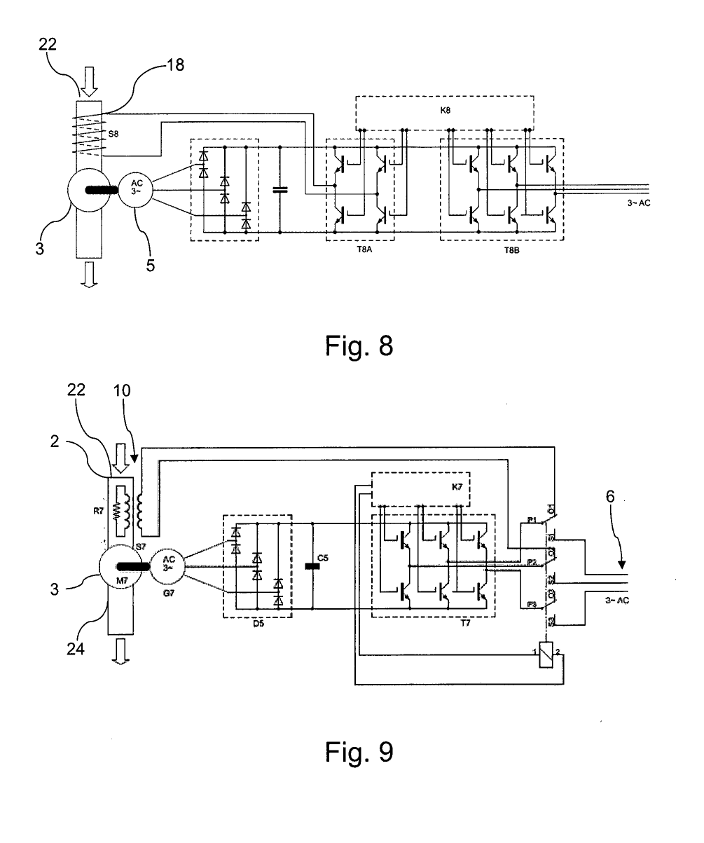

FIG. 8 shows a schematic block diagram for an AC generator and an appurtenant electrical element according to the FIGS. 6-7; and

FIG. 9 shows a schematic block diagram for an AC generator and an appurtenant electrical element of the inductive type in heat conducting connection with the driving fluid.

To better understand the examples, prior art is first reviewed. In FIG. 1 is shown a three-phase AC generator G2 supplying electrical energy to electric circuits where there is connected star-connected electrical elements R2A, R2B and R2C, one electrical element for each phase. In FIG. 2 is shown a three-phase AC generator G3 supplying electrical energy to electric circuits where there is connected delta-connected electrical elements R3A, R3B and R3C, one electrical element for each phase. It is also known that at large power outputs several electrical elements connected in parallel for each phase may be used.

A generator operating at varying rotational speeds will supply AC with varying frequency and voltage. Particularly the frequency will vary. Most energy consumers need AC with fixed frequency, typically 50 or 60 Hz. To be able to generate AC having the voltage and frequency needed in the distribution grid, a so-called frequency converter connected to the generator is used. FIG. 3 shows a known, simplified block diagram for a generator provided with a frequency converter. A turbine M4 is driven by a driving fluid indicated by arrows. The turbine M4 is mechanically connected to a three-phase generator G4, which thereby produces three-phase power. The three-phase electric current is rectified by the diodes in rectifier bridge D4. The DC from the rectifier bridge D4 is then smoothed in a condenser C4. The DC is then converted to an AC with fixed frequency in a power transistor module T4 controlled by an electronic control module K4. Thereby is achieved that the frequency of the produced AC is held stable by K4 while the generator G4 may vary in rotational speed and thereby frequency.

It is also known in the art that instead of a directly electrically connected resistive element, an inductive element may be used to create heat from electrical energy, a technique used for inductive heating in among other things cookers and melting furnaces. In practice there are very many small electrical elements each converting some eddy current to heat where the eddy current is induced in an electrically conducting material when it is exposed to an alternating magnetic field. The equivalent diagram for inductive heating is shown in FIG. 4. An electrical element R1 connected to an AC source G1 via two coils S1A and S1B. S1A consists of a normally wound coil while S1B is the equivalent inductance in the material to be heated. R1 is the equivalent electrical resistance absorbing an eddy current loss. FIG. 4 therefore shows an embodiment of an electrical element working by inductively connected load. An electrical element therefore works as a load whether it is directly connected or inductively connected.

FIG. 5 shows a block diagram where an inductively connected electrical element is used instead of a directly connected electrical element. A turbine M5 is driven by a driving fluid indicated with arrows. The turbine M5 is mechanically connected to a three-phase generator G5, which thereby produces three-phase power. The current is rectified by the diodes in a rectifier bridge D5. The DC voltage from the rectifier bridge D5 is then smoothed in a condenser C5. The DC voltage is changed to high frequency AC by the power-transistor module T5 controlled by the control module K5. A single coil, S5A, wound around a magnetic material will then induce eddy current being transformed to heat, illustrated by coil S5B and eddy current resistance R5. By having a high switching frequency it is also possible to not use magnetic materials such as aluminium and titanium alloys for R5. The person versed in the art will see that there is great likeness between FIGS. 4 and 5 so that the solution using inductively connected electrical elements may be integrated simply in a frequency converter solution and thereby save the separate power electronics for the inductively connected electrical element R5.

The invention will now be described referring to the FIGS. 6-9.

In FIGS. 6A-B the reference numeral 1 indicates a load resistor in accordance with the invention. A fluid line 2 containing a flowing driving liquid 22, where the flow direction is marked with an arrow, directs the driving fluid 22 through a turbine 3. The turbine 3 drives a generator 5 via a shaft 4. The electrical energy produced in the generator 5 is directed out onto an electrical distribution grid 6 via a control unit 62 where the control unit 62 may be constituted by a rectifier bridge, a condenser, a power transistor module and a control system. The control unit 62 is in electrically conducting connection with a load resistor 10 surrounding a portion of the fluid line 2 via a cable 64. In FIG. 6A the load resistor 10 surrounds a horizontal portion of the fluid line 2, and in FIG. 6B the load resistor 10 surrounds a vertical portion of the fluid line 2.

One embodiment of the load resistor 10 is shown in FIG. 7. The load resistor 10 surrounds a portion of the fluid line 2. A driving fluid 22 flows through the fluid line 2 as shown by an arrow. An annulus 12 is formed around a portion of the fluid line 2, so that the fluid line 3 constitutes one of the walls in the annulus 12, by a coaxial, outer casing 14, which is sealed against the fluid line 2 with at least one end wall 16. The portion of the fluid line 2 being surrounded by the casing 14 constitutes at least in parts of the portion of a heat conducting material such as a metal. The portion of the fluid line 2 being surrounded by the casing 14 is provided with an electrical element 18 in the form of a lengthy electrical resistance element. The electrical element 18 is fastened to the fluid line 2 in a per se known manner such that a good heat conducting contact is obtained between the electrical element 18 and the heat conducting material of the fluid line 2. The electrical element 18 is in a per se known manner connected to the control unit 62 by not shown electrical cables. For safety reasons and to avoid injury to personnel, the casing 14 is on its external side provided with an insulating material 17 of a per se known type, and the insulating material 17 is clad with a shell material 19 to hold the insulating material 17 in place on the casing 14.

As shown in FIG. 6A the load resistor may surround a horizontal portion of the fluid line 2. The annulus 12 is in this embodiment defined by two end walls 16. As shown in FIG. 6B the load resistor may surround a vertical portion of the fluid line 2. The annulus 12 is in this embodiment defined by a lower end wall 16. Advantageously the annulus 12 may in its upper end be provided with an expansion chamber (not shown) and this expansion chamber may be open to the surroundings or it may be closed with an upper end wall 16.

The annulus 12 may be provided with an inert, heat conducting cooling fluid such as transformer oil.

FIG. 8 shows a schematic block diagram for the embodiment example as shown in FIG. 7. The turbine 3 is driven by a driving fluid 22 as indicated by arrows. The turbine 3 is mechanically connected to a three-phase generator 5, which thereby produces three-phase power. The current is rectified by the diodes in a rectifier bridge. The DC voltage from the rectifier bridge is then smoothed in a condenser. The DC voltage is then changed to AC with fixed frequency in a power transistor module T8B controlled by an electronic control module K8. The electrical control module K8 also controls a power transistor module T8A, which may deliver AC to an electrical element S8. The person versed in the art will know that there may be one electrical element for each phase and that the electrical element S8 may be constituted by several electrical elements connected in parallel. At grid loss the control module K8 may direct all produced electrical energy to the electrical element S8. At grid loss the control module K8 may also direct a part of the produced electrical energy to a local grid via the power transistor module T8B based on the measured voltage. The turbine 3 will then be a backup power unit and function in isolated operation mode. The control module K8 will direct the surplus energy to the electrical element S8. Thereby is achieved that the turbine 3 may maintain its function and the amount of driving fluid 22 passing through the turbine 3 is unaffected by a grid loss.

An alternative embodiment for the load 10 is shown in FIG. 9. The electrical element 18 is constituted by an inductively connected electrical element as described in the FIGS. 4 and 5. In FIG. 9 the electrical element R7 is drawn as a part of a pipe wall 24 in the fluid line 2. The electrical element R7 is thereby cooled directly by the driving fluid 22. This has the advantage that the operation temperature of the electrical element R7 is lower than if the electrical element 18 is placed on the outside of the pipe wall 24 like a directly connected electrical element 18 as shown in FIGS. 7 and 8. Normal insulated electrical leads connected directly to the fluid line 2 may be used. Resistive alloys requiring special high temperature insulators and terminations are thereby made superfluous.

The relay/control unit K7 may switch between having the output from the frequency converter T7 connected to the distribution grid 6 at normal operation, or connected to the inductive electrical element R7 at grid loss. Apart from the need for extra control circuits to control the effect into R7 via T7 when the distribution grid 6 is out of operation, the solution is like a normal generator with a frequency converter as shown in FIG. 3.

A relay or a corresponding function is also required using a directly connected electrical element 18 as shown in FIG. 8, so that the number of additional components is largely identical to the solution shown in FIG. 8.

Use of an inductively connected electrical element 18 gives a simple mechanical design. Use of so-called high temperature materials, i.e. materials tolerating high operational temperature over an extended period of time is avoided. There is neither a need for good thermal contact between the fluid line 2 and the electrical element 18. Some heating will take place in the coil S7, but it is relatively little compared to the surface area in contact with the pipe wall 24, so that it is simple to keep the coil S7 at a low operating temperature.

In a further other embodiment (not shown) the housing of the turbine 3 itself may constitute the electrical element 18 if the housing is made of metal. This will give an integrated and compact installation.

In a further other embodiment (not shown) the electrical element 18 may be positioned inside the fluid line 2. In this embodiment the electrical element 18 may be constituted by a resistive element in direct contact with the driving fluid 22.

In the examples the load resistor 10 is positioned upstream of a fluid driven turbine 3. This has the advantage that the fluid line 2 in this portion will be filled with driving fluid 22 that may be heated at a possible closing down of the turbine 3. As mentioned it is not desirable for a pressure reduction turbine to be closed down, and the load resistor 10 may also be positioned downstream of the turbine 3 (not shown). The driving fluid 22 comprises in such an embodiment the fluid discharging from the turbine 3.

The person versed in the art will know that the described examples may be combined in further ways by use of a control module directing the electric energy produced between the local grid and the electrical element 18, that the electrical element 18 may be a resistive, inductive or capacitive electrical element 18 and the electrical element may be positioned upstream or downstream of the turbine 3.

1. A load resistor device for a generator driven by a turbine in a fluid string, the load resistor device comprising:
a load resistor is provided with at least one electrical element configured to be in heat conducting connection with the turbine driving fluid.

2. A load resistor device according to claim 1, wherein the electrical element is in heat conducting connection with a heat conducting pipe wall surrounding the driving fluid.

3. A load resistor device according to claim 1, wherein the load resistor is provided with an annulus surrounding a portion of a heat conducting pipe wall surrounding the driving fluid; wherein the annulus is provided with a cooling fluid and the electrical element is in heat conducting connection with the cooling fluid.

4. A load resistor device according to claim 3, wherein the cooling fluid is a heat inert and fire inert fluid.

5. A load resistor device according to claim 3, wherein the longitudinal direction of the annulus in the operational position is substantially vertical.

6. A load resistor device according to claim 3, wherein the annulus is provided with an expansion chamber.

7. A load resistor device according to claim 1, wherein the electrical element is an inductively connected electrical element.

8. A load resistor device according to claim 7, wherein a portion of the pipe wall constitutes the inductively connected electrical element.

9. A load resistor device according to claim 7, wherein a portion of a turbine housing constitutes the inductively connected electrical element.

10. A load resistor device according to claim 1, wherein the load resistor is provided with multiple electrical elements; and the electrical elements are connected to different phases and where the electrical elements may be connected in parallel.

11. A load resistor device according to claim 1, wherein a control unit for the generator is arranged to distribute the generator produced electrical energy between a distribution grid and the load.

12. A load resistor device according to claim 1, wherein the driving fluid is consumption water or oil.

13. A method in operating a turbine being driven by a driving fluid in a line network where the turbine is provided with a generator arranged to supply electrical energy to a distribution grid via a control unit, comprising:
directing, by the control unit, at grid loss the produced electrical energy to a load resistor provided with at least one electrical element in heat conducting connection with the turbine driving fluid.

14. A method according to claim 13, further comprising:
measuring, by the control unit, the electrical voltage in a local distribution grid;
providing, by the control unit, the local distribution grid with electrical energy according to the measured voltage; and
directing, by the control unit, surplus energy to the load resistor.
